(19) United States
(12) Patent Application Publication
(10) Pub. No.: US 2023/0157257 A1
(43) Pub. Date: May 25, 2023

(54) Methods and Apparatus for Pets

(71) Applicant: Smartec Products LLC, Phoenix, AZ (US)

(72) Inventors: Stephen Miller, Scottsdale, AZ (US); David White, New River, AZ (US); Eric Zemke, Peoria, AZ (US); Martin Diamond, Scottsdale, AZ (US)

(73) Assignee: Smartec Products LLC, Phoenix, AZ (US)

(21) Appl. No.: 18/146,758

(22) Filed: Dec. 27, 2022

Related U.S. Application Data
(63) Continuation-in-part of application No. 17/141,583, filed on Jan. 5, 2021.
Application No. 17/141,583 is a continuation-in-part of application No. 16/911,071, filed on Jun. 24, 2020, now Pat. No. 10,920,484.
(60) Provisional application No. 63/294,302, filed on Dec. 28, 2021.
(60) Provisional application No. 62/866,187, filed on Jun. 25, 2019.

(51) Int. Cl. A01K 1/03; A01K 1/01

(52) U.S. Cl. CPC A01K 1/033; A01K 1/0107

(57) ABSTRACT

A pet system according to various aspects of the present technology may comprise a pet apparatus configured to attach to a pet door, comprising an enclosure comprising a wall. The wall may include an entrance defined therethrough. A pet door interface may be connectable to the pet door. The pet door interface may define a substantially enclosed portal between the pet door and the entrance.

### CROSS-REFERENCES TO RELATED APPLICATIONS

This application is:
claims the benefit of U.S. Provisional Pat. Application No. 63/294,302, filed Dec. 28, 2021;
is a continuation-in-part of U.S. Pat. Application Serial No. 17/141,583, filed Jan. 5, 2021, which is a continuation-in-part of U.S. Pat. Application Serial No. 16/911,071, filed Jun. 24, 2020, which claims the benefit of U.S. Provisional Pat. Application No. 62/866,187, filed Jun. 25, 2019; and
incorporates the disclosure of each application listed above by reference.

### BACKGROUND

Pets enrich the lives of families and individuals around the world, providing companionship, love, protection, and entertainment. For many pet owners, nothing is more important than the safety, comfort, and well-being of their pets. Pets may even occupy a position comparable to children.

The cleanup and unpleasant smell of litter, however, is a frequent problem for cat and other pet owners. Many pets also want to go outside or view the outdoors, but many owners fear that the pet could run away or be in danger if allowed to go outdoors. Owners enjoy watching their pets in a playful environment like cat trees or cat patios and would like additional options that could be environmentally controlled. Many people have pet doors already installed in their home that they cannot use for fear of their pet escaping.

### SUMMARY

Methods and apparatus for pets according to various aspects of the present technology may comprise a pet apparatus configured to attach to a pet door and comprising an enclosure comprising a wall. The wall may include an entrance defined therethrough. A pet door interface may be connectable to the pet door. The pet door interface may define a substantially enclosed portal between the pet door and the entrance.

### BRIEF DESCRIPTION OF DRAWING FIGURES

A more complete understanding of the present technology may be derived by referring to the detailed description and claims when considered in connection with the following illustrative figures. In the following figures, like reference numbers refer to similar elements and steps throughout the figures.

FIG. 1 is a cross-section side view of a pet system according to various aspects of the present technology.

FIG. 2 is a perspective view of a pod.

FIG. 3 is an exploded view of a pod.

FIGS. 4A-F are top, cross-section side, cross-section top, rear, side, and front views, respectively, of a pod.

FIG. 5 is a cross section view of a dog door system.

FIG. 6 is an exploded view of a dog door system.

FIGS. 7A-B are side views of a pet door tunnel.

FIG. 8 is a perspective view of a pet door system with a security panel holder.

FIGS. 9A-B are perspective views of a pod.

FIGS. 10A-B are rear views of pods with stands.

FIG. 11 is an exploded view of a pod with a removable tray.

FIG. 12 is a side vide of a pod with a connector tunnel.

FIGS. 13A-D are views of multiple interconnected pods.

Elements and steps in the figures are illustrated for simplicity and clarity and have not necessarily been rendered according to any particular sequence. For example, steps that may be performed concurrently or in different order are illustrated in the figures to help to improve understanding of embodiments of the present technology.

### DESCRIPTION OF EXEMPLARY EMBODIMENTS

The present technology may be described in terms of functional block components and various processing steps. Such functional blocks may be realized by any number of hardware or software components configured to perform the specified functions and achieve the various results. For example, a system according to various aspects of the present technology may employ pods, connectors, power sources, waste collection systems, and the like, which may carry out a variety of functions. In addition, the present technology may be practiced in conjunction with any number of access systems and animal control systems, and the system described is merely one exemplary application for the technology. Further, a system according to various aspects of the present technology may employ any number of conventional techniques for connection, ventilation, waste collection, and the like.

Methods and apparatus for pets according to various aspects of the present technology may operate in conjunction with a pod that can be entered by a pet. The pod may be configured to connect to a pet door such that the pod can be placed outdoors but remain accessible to the pet via the pet door. The pet can enter the pod through the pet door without exposure or physical access to the outdoor environment. In various embodiments, the pod may be connected to the pet door via a nondedicated security panel holder outside an owner’s home for an already-installed legacy pet door, via a dedicated security panel holder that engages the pod outside the owner’s home around the pet door, another fastener that attaches the pod to structure around the pet door, and/or via a tunnel or other connection between the pet door and the pod.

In various embodiments, the pod may not be connected to a pet door, and instead allows entry directly through the pod entrance. For example, the pod may be placed indoors or outdoors to provide the pet with a freestanding litter box pod area and/or play system.

The pod may also be configured to couple to other pods, such as through aligned openings in the walls of the pods and/or one or more tunnels. Connecting multiple pods can provide a play system that connects together for pets, which may be entertaining for the owners to design and watch their pets enjoy.

The pod may include a waste collection system to isolate the mess and odors associated with pet waste from the owner’s home. For example, the pod may include a tray for cat litter. The tray may be removable from outside the pod so the litter may be disposed of and replaced without the cat litter entering the owner’s home.

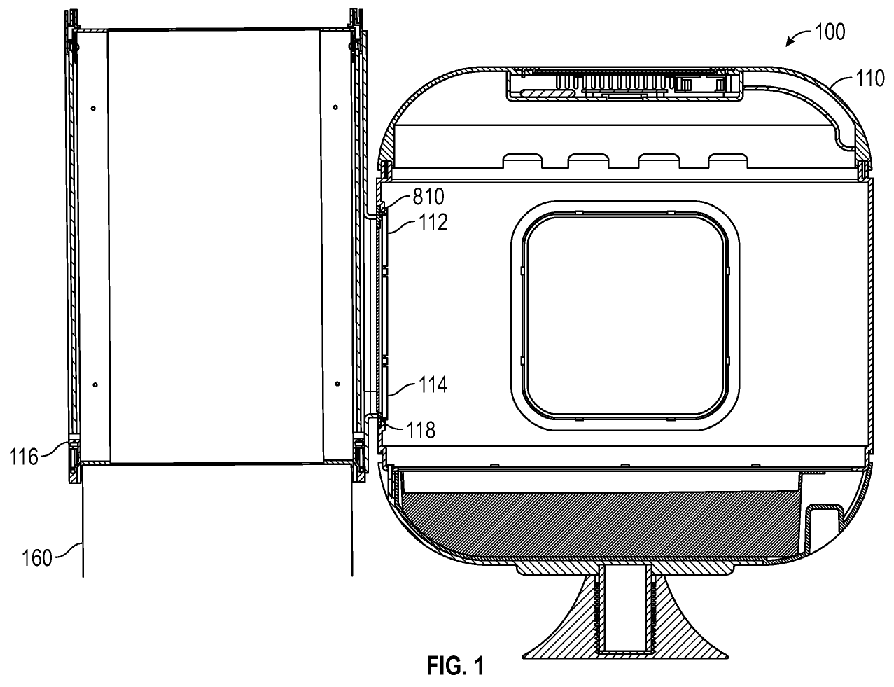

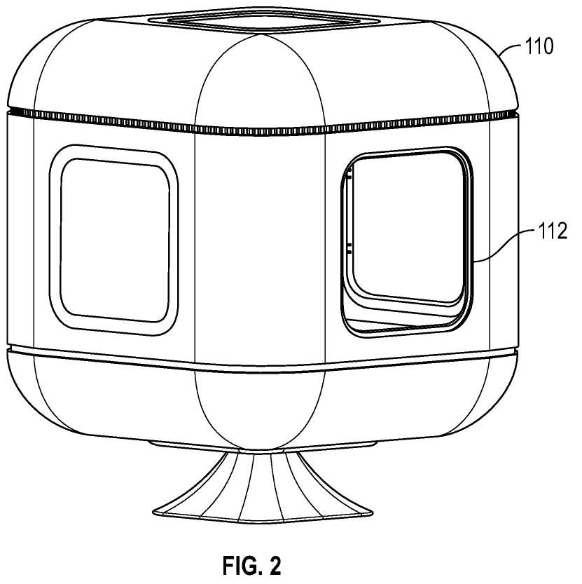

For example, referring to FIGS. 1 through 4A-F, methods and apparatus for pets according to various aspects of the present technology may operate in conjunction with a pet system 100 comprising an embodiment of a pod 110 with an entrance 112 for a pet and a pet door interface 118. The pod 110 provides a substantially enclosed space for the pet to occupy, and the entrance 112 allows the pet to enter and exit the pod 110, such as via a pet door of a main structure 160, like a pet owner’s home.

The pet door interface 118 defines a substantially enclosed portal between the pet door and the entrance 112. In this context, a substantially enclosed portal is a structure permitting a pet to pass through between the pet door and the pod 110 but with no access to the outside environment. Thus, while the substantially enclosed portal may not be entirely enclosed, such as due to ventilation holes, the substantially enclosed portal confines the pet movement.

The pet door may be any opening to allow pets like dogs and cats to enter and exit a building without requiring a human to open the door. Pet doors may range from simple holes to an opening in a wall or larger door with a hinged and possibly spring-loaded panel or flexible flap, and/or an electronically controlled door or flap. Such pet doors typically inhibit entry of unwanted wind, rain, and larger-bodied intruders. Pet doors may also be referred to or implemented as pet flaps, cat flaps, cat doors, kitty doors, dog flaps, dog doors, or doggy/doggie doors.

The pod 110 provides a space large enough for the pet to enter and move. The pod 110 may comprise any appropriate configuration and material. In the present embodiment, the pod 110 comprises a substantially rigid weather-resistant plastic and is sized to accommodate the normal range of house cats. For example, the pod 110 may be 8-19 inches high and 11-22 inches in length and width or diameter. The dimensions may be adjusted within or beyond these dimensions according to the size and type of pet and anticipated uses of the pod 110. For example, smaller dimensions may be suitable for a pod 110 expected to be used primarily as a litter box or a resting area; larger dimensions may be suitable for an anticipated play area or for larger animals.

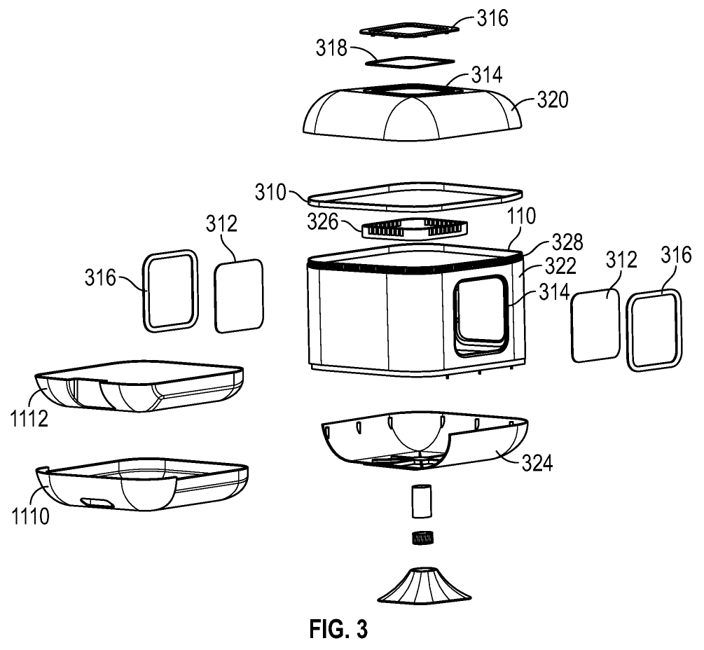

In the present embodiment, the pod 110 comprises an enclosure, i.e., a structure defining a substantially enclosed interior space, such as a shell structure with one or more apertures like entrances/exits, windows, and/or vents. Referring to FIG. 3, the enclosure may comprise a top section 320, a side section 322, and a bottom section 324 assembled to form the enclosure. The side section forms walls, which may have apertures formed in them.

The entrance 112 allows the pet to enter and exit the pod 110. The entrance 112 may be sized appropriately for the pet to pass through. For example, the entrance 112 may be 4-19 inches high and 5-22 inches in width or diameter for an entrance intended for house cats. The entrance 112 may include a door, which may be opened by the pet, such as a flap, spring-biased door, or motorized door, or may be no more than an opening formed in the wall of the pod 110.

In the present embodiment, the entrance 112 includes one or more flaps 114 that cover the opening into the pod 110 and move away when pushed by the pet. The flap 114 inhibits transfer of odors through the pet door or other access point into the main structure 160 without inhibiting passage of the pet. The flap 114 may comprise any appropriate system for limiting odors, noise, airflow, dust, dampness, and the like through the passage while still permitting the pet to pass through. In various embodiments, the flap 114 may comprise a tear-resistant flexible material hanging from the top of the entrance 112 and/or the tunnel or a rigid lightweight material hanging via a hinge.

The flap 114 may include features to enhance its functionality. For example, the flap 114 may engage weatherstripping, such as a low-profile fuzzy weatherstripping, attached to the edges of the frame to inhibit airflow around the flap 114. The flap 114 may also comprise an opaque or translucent material to reduce visibility of smudges and dirt. In the present embodiment, the flap 114 comprises translucent vinyl with metal strikes molded into the vinyl to reduce noise as the flap 114 closes. The bottom of the flap 114 may include a metal strike to enhance the seal, such as a metal strike along the entire bottom edge of the flap 114.

Referring to FIG. 1, in various embodiments, the pod 110 may be placed outdoors and connected to another structure 160, such as a home adjacent the entrance 112. For example, the entrance 112 may be aligned with the exterior of a pet door system 116. The pod 110 may be secured in position to maintain the alignment of the entrance 112 to the pet door system 116. The pod 110 may be secured in any suitable manner using a secure and/or removable connector.

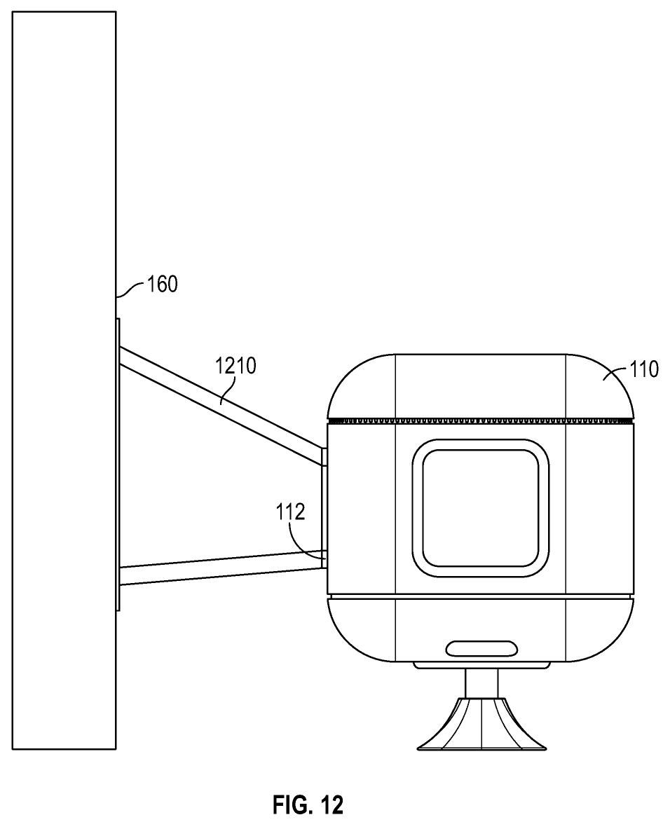

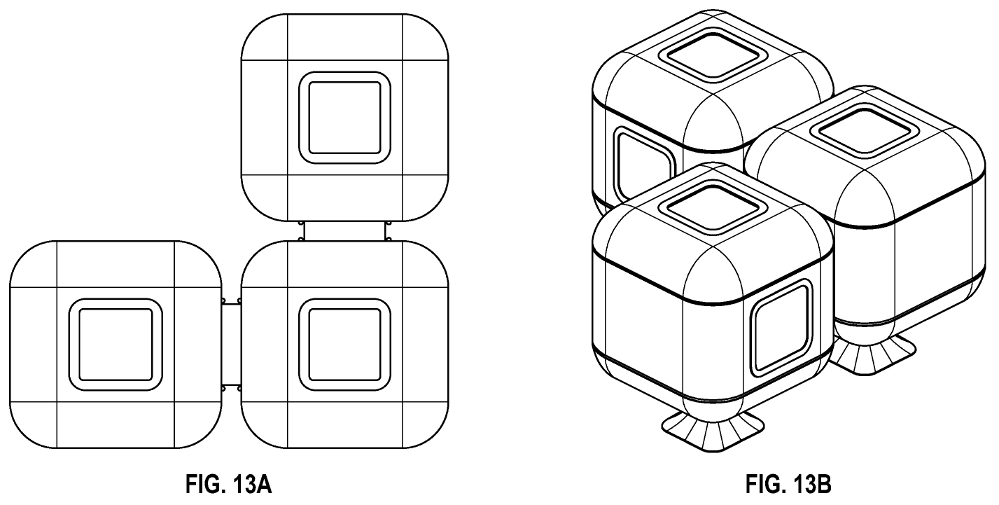

In various embodiments, a pet door interface 118 includes the connector. For example, the pet door interface 118 may be positioned adjacent the entrance 112, may be connectable to the pet door system 116, and may maintain the alignment between the entrance and the pet door so the pet can pass through both. For example, the pet door interface 118 may secure the entrance 112 in its aligned position directly to the main structure 160. In other embodiments, referring to FIG. 12, the pet door interface 118 may provide access to the entrance 112 indirectly, like via a connector tunnel 1210 connectable between the entrance 112 and the pet door system 160. The pet door interface 118 may affix one end of the connector tunnel 1210 or the pod 110 to the main structure 160 with a connector, such as permanent fasteners like nails, bolts, or screws. Alternatively, the pet door interface 118 may removably attach the connector tunnel 1210 or pod 110 to the main structure 160.

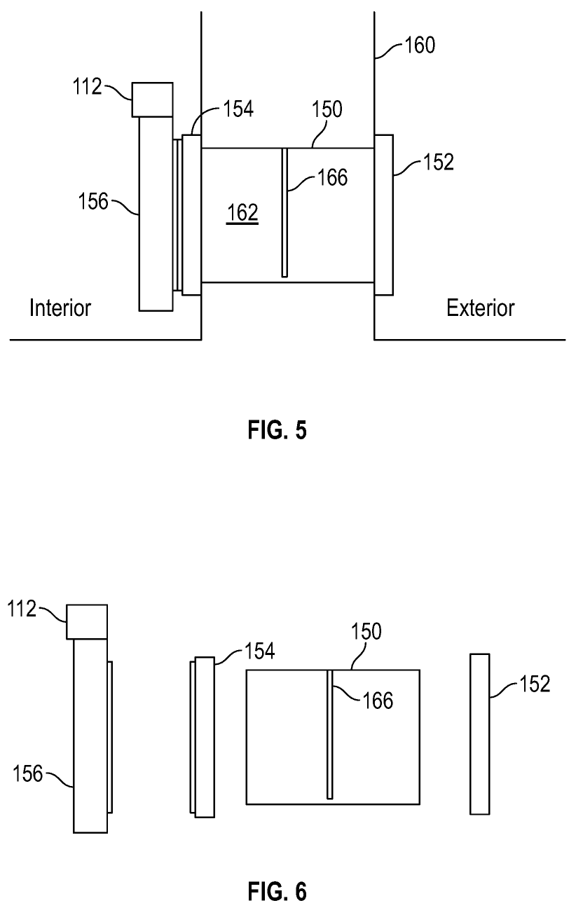

Referring to FIGS. 5 and 6, in various embodiments, the pod 110 operates in conjunction with dedicated elements, such as a dedicated wall tunnel 150 and exterior and interior frames 152, 154, but may also or alternatively function with legacy pet door systems, such as a pre-existing and unrelated passage 162 and a legacy security panel holder around the passage 162.

The pod 110 may operate in conjunction with legacy pet door systems, and the pod 110 may also be configured to operate with dedicated elements. For example, referring again to FIGS. 1 and 5-6, the pod 110 may be accessed via a wall tunnel 150, an exterior frame 152, and an interior frame 154 as dedicated interoperable elements. The wall tunnel 150 defines a passage 162 for the pet through the hole in the structure 160, such as through a wall or door. The passage 162 may comprise a legacy passage or a new opening through the structure 160. The wall tunnel 150 separates the interior of the passage 162 from the rough interior surfaces of the structure 160, such as drywall, insulation, and wall studs, and provides a finished interior surface defining the passage 162. The wall tunnel 150 may also engage one or both frames 152, 154. The wall tunnel 150 may comprise a substantially rigid and smooth material, such as metal, plastic, or wood.

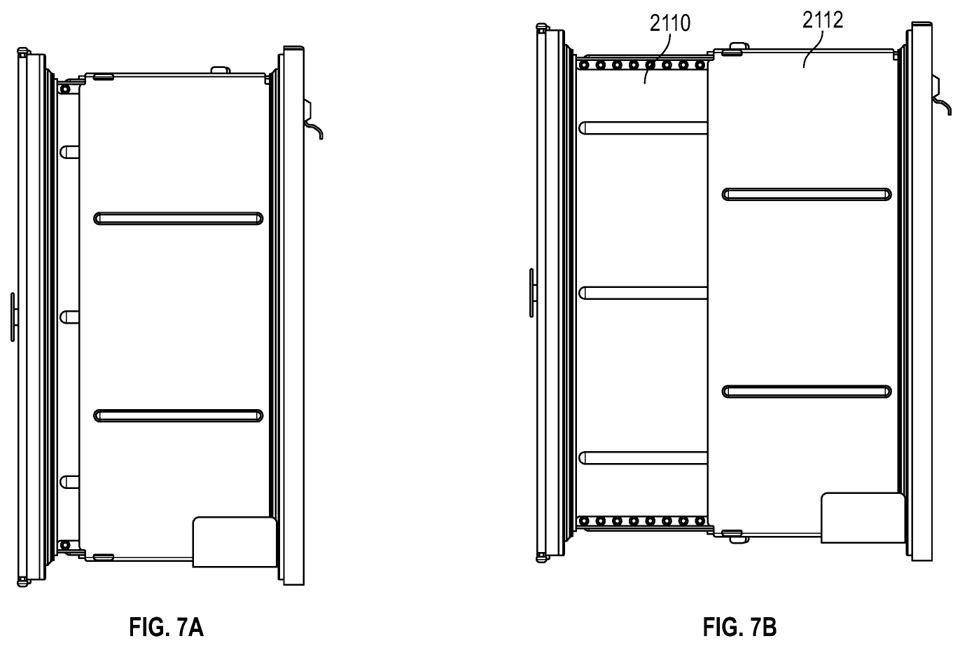

In one embodiment, the wall tunnel 150 comprises a collapsible reinforced aluminum tunnel that requires no cutting to install. For example, referring to FIGS. 7A-B, the wall tunnel 150 may comprise two main sections 2110, 2112 that may be joined. In various embodiments, one main section 2110 slides into the opening from the interior, and the second main section 2112 slides into the opening from the exterior. One main section may slide into the other in a telescoping manner so that the length of the tunnel may be adjusted according to the wall thickness. The two sections 2110, 2112 may then be joined together in position, such as using one or more fasteners, to form a single continuous tunnel.

In addition, the wall tunnel 150 may comprise subsections to be assembled on-site. In one embodiment, each tunnel section comprises multiple wall sections, such as eight sections, that snap into a receiving portion of the interior frame 154 and exterior frame 152, respectively. Thus, the wall tunnel 150 may break down into individual pieces and a relatively flat package for shipping, assembly, and storage. The wall tunnel 150 may, however, comprise any appropriate elements and materials for defining the passage 162.

The exterior frame 152 defines a perimeter around the exterior end of the passage 162. In various embodiments, the exterior frame 152 comprises a rigid weather resistant material, such as metal, plastic, or wood. In one embodiment, the external frame 152 comprises a composite material that is resistant to outdoor elements, such as humidity, water, heat, cold, and ultraviolet exposure, such as steel reinforced aluminum. The exterior frame 152 may attach to the wall tunnel 150 and may obscure the end of the wall tunnel 150 and the surrounding edges of the hole in the structure 160. The exterior frame 152 may also provide structures for mounting other elements, such as the pod 110, a connector tunnel leading to the pod 110, a security panel, a solar panel, a ramp, or a shade/shelter.

The interior frame 154 defines a perimeter around the interior end of the passage 162. In various embodiments, the interior frame 154 comprises a substantially rigid material, such as metal, plastic, or wood. The interior frame 154 may attach to the wall tunnel 150 and may obscure the end of the wall tunnel 150 and the surrounding edges of the hole in the structure 160. In various embodiments, the interior frame 154, the exterior frame 152, and/or the wall tunnel 150 comprise extruded aluminum, which may facilitate assorted sizes by cutting various lengths of the frame and tunnel pieces. The interior frame 154 may also provide structures for mounting other elements, such as a solar panel or a ramp.

One or more security panels may also selectively block the passage 162 with a physical barrier, such as in addition to or instead of a door unit 156. The security panel provides a barrier that can securely disable the passage 162, such as when the owner is departing for an extended time and/or removing the pod 110 from the exterior frame 152 and/or the door unit 156 from the interior frame 154. The security panel may comprise any appropriate barrier for blocking the passage 162. For example, the security panel may comprise a rigid and sturdy panel that may be secured across the passage 162 to form a barrier. In one embodiment, the security panel comprises a rectangular panel of metal, wood, or plastic that engages the interior frame 154 and/or the exterior frame 152 to block access through the wall tunnel 150.

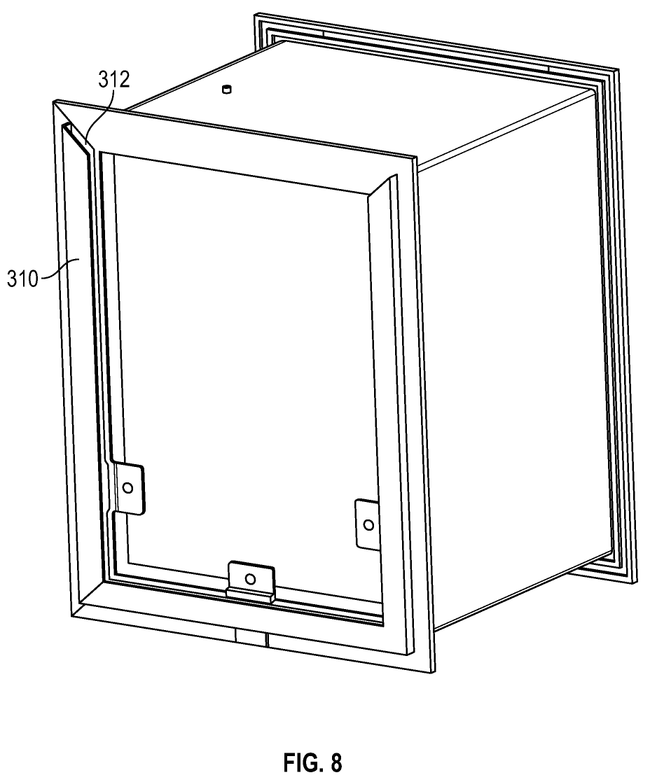

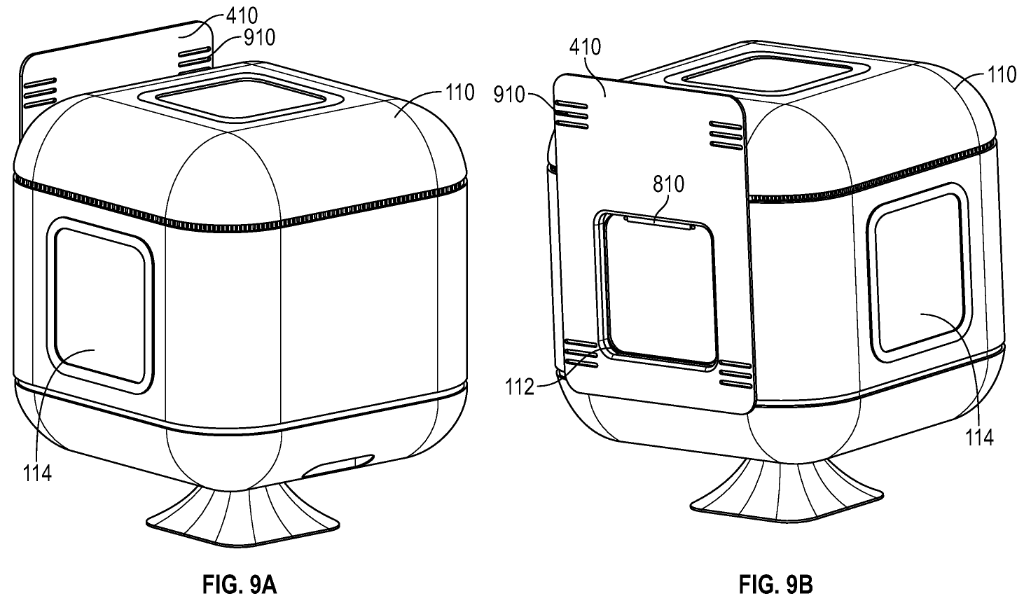

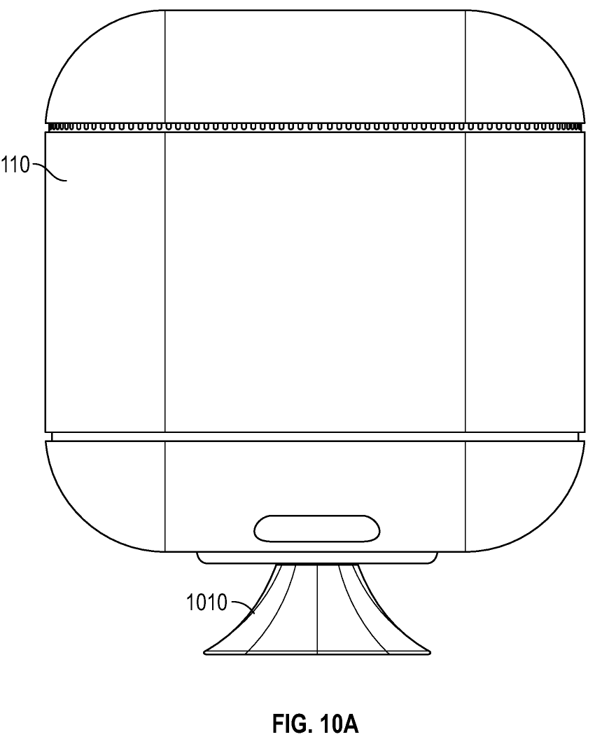

The exterior frame 152 and/or the interior frame 154 may be configured to engage the security panel. In various embodiments, referring to FIG. 8, the frame 152, 154 may include a mounting structure, such as a structure like the security panel holder 310, configured to engage the lower and lateral perimeter of the security panel and/or a corresponding mounting structure on the pod 110 and/or back of the door unit 156. In the present embodiment, at least one of the frames 152, 154 includes a grooved mounting structure 312, such as grooves on the lateral edges of the frame. In one embodiment, the groove is open to the interior edge of the frame. The security panel may be secured to the frame 152, 154 by sliding a connector on the security panel or the entire security panel into the lateral grooves through the open top of the groove until it rests on the bottom of the grooved mounting structure 312. The security panel may include a lock, such as a keyed lock or a manual pin lock, to secure the security panel in place and inhibit removal.

In various embodiments, an exterior security panel may be secured across the exterior end of the tunnel 150, such as an exterior security panel that slides onto the exterior frame 152 on the outside of the home or other structure. The exterior security panel may cover most or all of the exterior frame 152. In some embodiments, the exterior security panel may be locked from inside the tunnel 150 and may locked without a need for a key. Other embodiments may use a key-operated lock. The exterior security panel may secure the home or structure for relatively lengthy periods, such as by securing the tunnel 150 to deter intruders and inhibit rain, snow, leaves, and/or other debris from entering the tunnel 150.

The exterior frame 152, the interior frame 154, and/or another element associated with the main structure 160 may be configured to engage the pod 110. In various embodiments, the frame 152, 154 may include a mounting structure configured to engage the pod 110 around the entrance 112, such as via a permanent or removable coupling, for example using a structure on the frame 152, 154 that couples to a corresponding structure on the pod 110. In various embodiments, the coupling uses dedicated structures on the frame 152, 154 and the pod 110 that are designed solely to couple the frame 152, 154 to the pod 110. In other embodiments, other elements may also connect to the frame 152, 154 and/or the pod 110 via the coupling, such as a connector tunnel to connect the frame 152, 154 to the pod 110.

The pod 110 may also be secured to the main structure 160 via a legacy security panel holder from an unrelated legacy system. Many pet door systems include a security panel holder to receive a security panel. The legacy pet door system’s security panel holder may comprise a slotted security panel holder having a geometric shape, such as rectangular, to support a security panel.

For example, referring again to FIG. 8, an example security panel holder 310 is configured to engage the lower and at least one lateral edge of a security panel. The security panel holder 310 includes the grooved mounting structure configured to engage the security panel, such as a grooved mounting structure extending away from the end of the tunnel and forming a rectangle with an open top or side. The grooved mounting structure may comprise a wall protruding substantially perpendicularly from the vertical surface of the wall surrounding the opening with a groove that is open toward the interior of the mounting structure.

The legacy security panel holder 310 may be substantially rectangular to receive a substantially rectangular security panel. The security panel may be secured to the security panel holder 310 by sliding the security panel into the groove through the open top or side of the mounting structure until it rests on the bottom or opposite side of the groove along the bottom or opposite side of the rectangle.

In various embodiments, the pod 110 may be connected to a nondedicated structure (i.e., a structure originally intended to connect to something else or serve another purpose), such the legacy security panel holder, to attach the pod 110 to the main structure 160 over the passage 162 opening. The pod 110 provides pet access through the passage 162 and entrance 112 and may be mounted on the legacy security panel holder 310. The connection between the pod 110 and the main structure 160 may be permanent or removable.

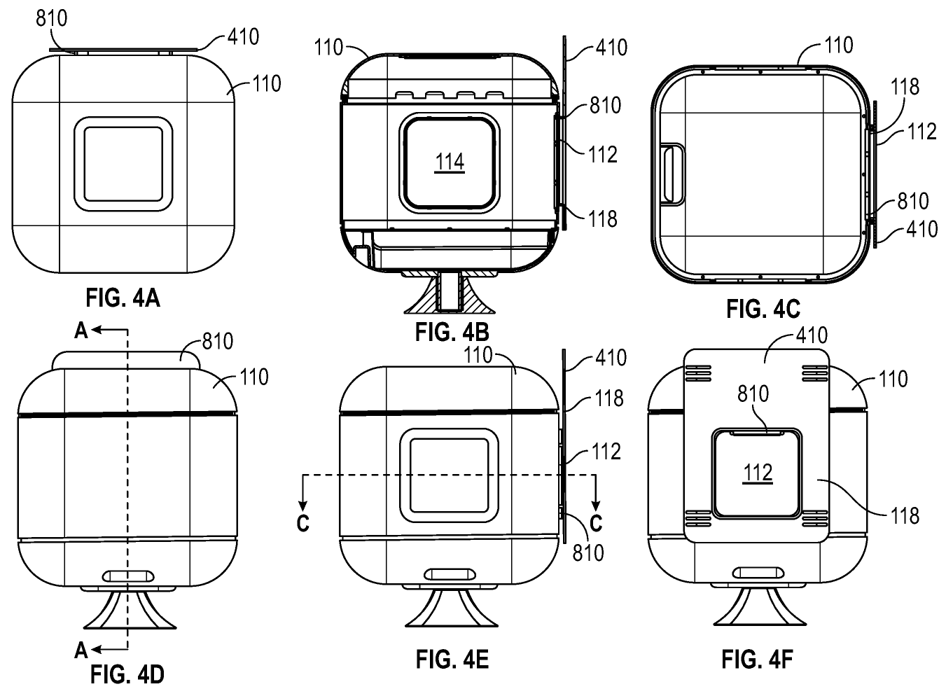

For example, the pod 110 may include a security panel interface configured to engage the security panel holder such that the pet door interface connects to a security panel holder. In the present embodiment, referring to FIGS. 1, 4A-F and 9A-B, the security panel interface may comprise a hang structure 810 extending from the pod 110 around the entrance 112 and substantially matching the geometric shape of the slotted security panel holder 310. The hang structure 810 includes a lip extending outwardly from the protruding edge of the hang structure 810, forming a groove in the exterior of the hang structure 810 to engage the slotted security panel holder 310 by sliding into the groove of the security panel holder 310. The hang structure 810 may comprise any suitable material, such as extruded aluminum, that slides into the existing pet door security panel grooves.

The connection between the pod 110 and the main structure 160 and/or the legacy security panel holder 310 may be implemented in any suitable manner. In various embodiments, the pet door interface is modifiable to connect to multiple security panel holder geometries. For example, the pet door interface may include modular connectors that attach to the pod 110 and match assorted sizes and configurations of security panel holders from different manufacturers, or adjustable connectors that attach to the pod 110 and may be adjusted to fit assorted sizes and configurations of security panel holders from different manufacturers.

In the present embodiment, the hang structure 810 may comprise or operate in conjunction with a modular system comprising multiple different mount adapters configured to match assorted sizes and types of security panel holders 310. Each mount adapter may be configured to be removably mounted on the pod 110, such as via the hang structure 810 around the entrance 112 or other attachment mechanism. The user may select the appropriate mount adapter that matches the legacy security panel holder 310, or adjust the mount adapter to match the legacy security panel holder 310, and mount the mount adapter on the legacy security panel holder 310 and mount the pod 110 on the mount adapter.

In one embodiment, referring to FIGS. 4A-F and 9A-B, an example mount adapter 410 may be removably or permanently attached to the side of the pod 110 around the entrance 112, for example via the hang structure 810. The mount adapter 410 may be attached to the pod 110 in any suitable manner, however, such as via a friction fit, snap connection, clips, fasteners, adhesive, and the like.

The mount adapter may be removably or permanently attached to main structure 160 in any suitable manner. For example, the mount adapter 410 may include slots 910 through which screws, nails, or other fasteners may be disposed to removably or permanently attach the mount adapter 410 to the main structure 160. The mount adapter 410 may also engage the legacy security panel holder 310 of a conventional pet door. For example, the appropriate size and/or shape of mount adapter 410 may be selected from a collection of mount adapters 410 according to the legacy security panel already installed on the main structure 160. The selected mount adapter 410 may be attached to the pod 110 and then fitted onto the legacy security panel holder 310, such as by sliding the mount adapter 410 into the slot of the legacy security panel holder 310.

In one embodiment, the mount adapter 410 includes a security panel holder that can receive a security panel and/or the hang structure 810 positioned around the entrance 112 of the pod 110. This configuration allows the pod 110 to be removed from the mount adapter 410 and replaced with a security panel, such as when the owner wishes to secure the pet door.

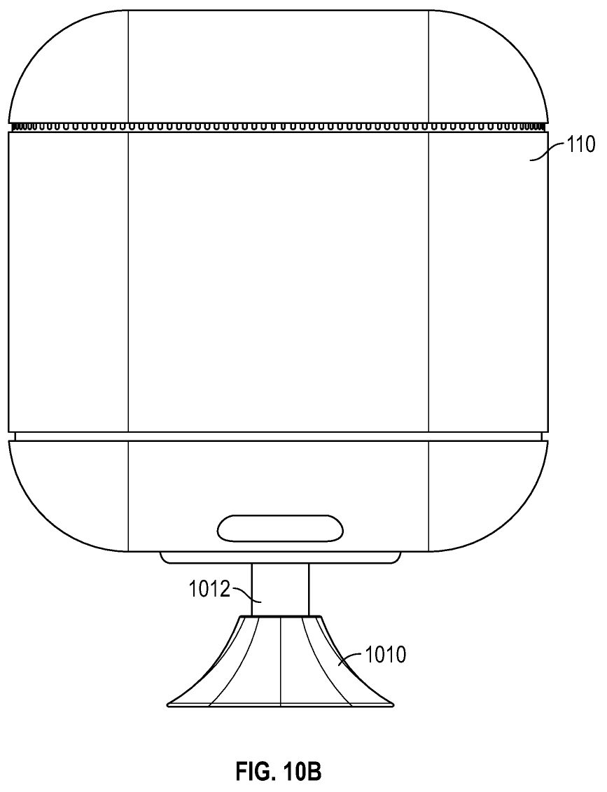

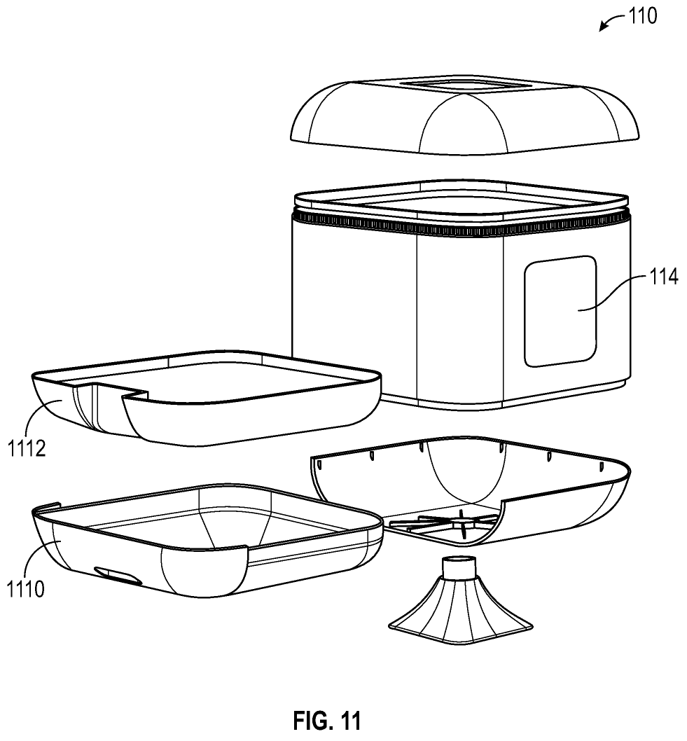

The pod 110 may also be supported by other elements to maintain the position of the pod 110. Support elements may comprise any suitable elements for stabilizing the pod 110, such as legs, supports, brackets, braces, jacks, restraints, straps, connectors, and the like. In the present embodiment, referring to FIGS. 10A-B, the pod 110 includes an adjustable stand 1010 that supports the bottom of the pod 110 and rests in the ground or floor. The stand 1010 may be adjusted with a telescoping support 1012 to maintain the position of the pod 110.

The pod 110 may include a waste collection system, such as a feces and urine collection system. The waste collection system may comprise any appropriate system for collecting and removing pet waste. In various embodiments, referring to FIGS. 3 and 11, the waste collection system comprises an area at the bottom of the pod 110 for holding litter, such as a removable tray 1110 so that the tray may be removed from the pod 110 to change the litter. The tray 1110 may be configured to be removable through the entrance 112. Alternatively, the tray may be removable without passing through the entrance 112, such as to avoid transporting used litter into or through the main structure 160.

For example, the waste collection system may include a removable tray 1110 positioned on the bottom of the pod 110 and containing litter or other appropriate material. The tray 1110 may be removed from outside the pod 110 by sliding it laterally out of the pod 110. The tray 1110 may contain a litter cartridge 1112, which may be removed from the tray 1110 and replaced. Because the pod 110 may be positioned outdoors and the tray 1110 may be removed and replaced from outside the pod 110, the odors and mess associated with the waste collection system are relatively isolated from the home or other structure 160.

The pod 110 may include a ventilation and/or odor control system, such as to circulate fresh air into the pod 110 and remove odors. The ventilation and/or odor control system may comprise any suitable components, such as a vent to the outside environment, a fan, a filter system, and/or deodorizing elements. For example, referring again to FIG. 3, the present pod 110 includes a fan 326 disposed in fluid communication with a grille 328 in the top and/or side of the pod 110. The pod 110 may further include a carbon filter 310.

The pod 110 may also include additional openings and elements, such as to entertain and soothe the pet. For example, the pod 110 may include one or more windows 312 formed in the sides or roof of the pod 110, such as to allow the pet to view the surrounding environment. The pod 110 may also include toys or other entertainment elements, such as bells on strings, feathers, motion activated toys and attractions, dots generated by lasers, lights, etc. The entertainment elements may be integrated into the pod 110 or removable.

In various embodiments, the pod 110 includes openings 314 in one or more of the sides, roof, and floor that are securable to multiple different components. Thus, each opening 314 can receive replaceable elements. For example, each opening 314 may include an opening adapter 316 to receive distinct kinds of elements, such as by snapping the elements into place. In one embodiment, a window 312 may be initially installed in an opening. The window 312 may be removed from the opening adapter 316 and replaced with another element, such as a panel equipped with toys.

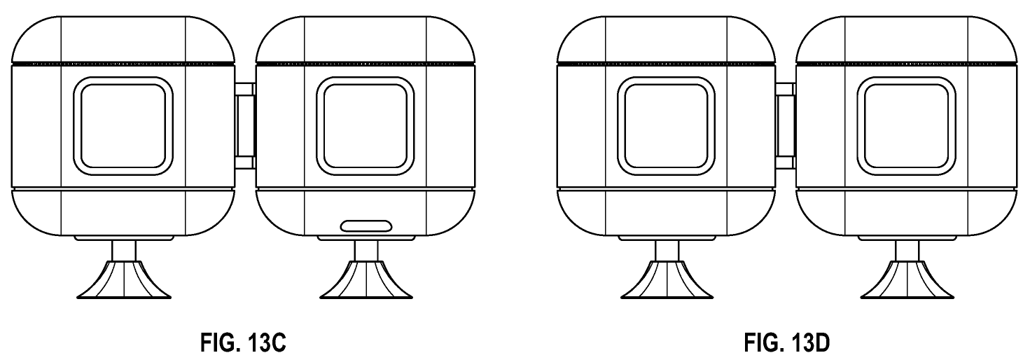

The opening 314 may also be used to provide access to a second enclosure. For example, referring to FIGS. 13A-D, the opening 314 may receive and removably secure a tunnel or other connections to a separate pod, for example to connect the pod 110 to other pods and/or passages to other pods or other structures, such as to create a multi-pod habitat.

The fan and other electrical components may receive power from any suitable power source, such as power from the main structure 160, a battery, and/or solar panel 318 (FIG. 3). The power source may supply power to other systems, such as doors, cameras, motion detectors, toys, and lights. The various powered elements may be controlled by any suitable system, such as a control panel connected to the pod 110, a dedicated remote control, a remote computer, or an app on a personal device like a cellular phone or tablet.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits and other advantages and solutions to problems have been described above with regard to particular embodiments. Any benefit, advantage, solution to problem, or any element that may cause any particular benefit, advantage, or solution to occur or to become more pronounced, however, are not to be construed as critical, required, or essential features or components of any or all the claims.

As used herein, the terms “comprise,” “comprises,” “comprising,” “having,” “including,” “includes,” or any variation thereof, are intended to reference a non-exclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters or other operating requirements without departing from the general principles of the same.

1. A pet apparatus configured to attach to a pet door, comprising:
an enclosure comprising at least one wall, wherein the wall includes an entrance defined therethrough; and
a pet door interface connectable to the pet door, wherein the pet door interface defines a substantially enclosed portal between the pet door and the entrance.

2. A pet apparatus configured to attach to a pet door according to claim 1, wherein the wall includes an opening providing access to a second enclosure.

3. A pet apparatus configured to attach to a pet door according to claim 1, wherein the pet door interface is disposed adjacent the entrance and maintains an alignment between the entrance and the pet door.

4. A pet apparatus configured to attach to a pet door according to claim 1, wherein the enclosure further comprises a waste collection system.

5. A pet apparatus configured to attach to a pet door according to claim 4, wherein the waste collection system comprises a removable tray disposed at a bottom of the enclosure.

6. A pet apparatus configured to attach to a pet door according to claim 1, wherein the enclosure includes an opening securable to multiple different components.

7. A pet apparatus configured to attach to a pet door according to claim 1, wherein the pet door interface connects to a security panel holder.

8. A pet apparatus configured to attach to a pet door according to claim 7, wherein the pet door interface is modifiable to connect to multiple security panel holder geometries.

9. A pet apparatus configured to attach to a pet door according to claim 1, wherein the pet door interface comprises a tunnel connectable between the entrance and the pet door.

10. A pet apparatus configured to attach to a pet door, comprising:
an enclosure, comprising:
a first opening defined through a first side of the enclosure providing access to the pet door; and
a second opening defined through a second side of the enclosure comprising a window;
a pet door interface adjacent the first opening and connectable to the pet door, wherein the pet door interface defines a substantially enclosed portal between the pet door and the first opening; and
a tray at the bottom of the enclosure, wherein the tray is removable.

11. A pet apparatus configured to attach to a pet door according to claim 10, further comprising a third portal defined through a third side of the enclosure and providing access to a second enclosure.

12. A pet apparatus configured to attach to a pet door according to claim 10, wherein the pet door interface is disposed adjacent the entrance and maintains an alignment between the entrance and the pet door.

13. A pet apparatus configured to attach to a pet door according to claim 10, wherein at least one of the openings is securable to multiple different components.

14. A pet apparatus configured to attach to a pet door according to claim 10, wherein the pet door interface connects to a security panel holder.

15. A pet apparatus configured to attach to a pet door according to claim 14, wherein the pet door interface is modifiable to connect to multiple security panel holder geometries.

16. A pet apparatus configured to attach to a pet door according to claim 10, wherein the pet door interface comprises a tunnel connectable between the entrance and the pet door.

17. A method of connecting an enclosure to a pet door having an opening, comprising:
aligning an entrance of the enclosure with the opening; and
connecting a pet door interface between the enclosure and the pet door, wherein the pet door interface defines a substantially enclosed portal between the pet door and the entrance.

18. A method of connecting an enclosure to a pet door according to claim 17, wherein connecting the pet door interface comprises connecting the pet door interface to a security panel interface of the pet door.

19. A method of connecting an enclosure to a pet door according to claim 18, wherein connecting the pet door interface comprises modifying the pet door interface according to a geometry of the security panel interface.

20. A method of connecting an enclosure to a pet door according to claim 17, wherein connecting the pet door interface comprises connecting a tunnel between the pet door and the entrance.
